(19) United States
(12) Patent Application Publication
(10) Pub. No.: US 2020/0148002 A1
(43) Pub. Date: May 14, 2020

(54) SNOWBLOWER WHEEL ATTACHMENT

(71) Applicant: Ronald Fehntrich, Brentwood, NY (US)

(72) Inventor: Ronald Fehntrich, Brentwood, NY (US)

(21) Appl. No.: 16/185,313

(22) Filed: Nov. 9, 2018

(51) Int. Cl. B60B 37/00; B60B 35/00; B60B 35/04; E01H 5/08

(52) U.S. Cl. CPC B60B 37/00; E01H 5/08; B60B 35/04; B60B 35/004

(57) ABSTRACT

A method to elevate a snowblower that includes the steps of: assembling a wheelbase, wherein said wheelbase includes a first wheel and a second wheel placed on a horizontal axle and a vertical post extending therefrom; inserting bolts through a mounting platform attached to the vertical post; and securing the bolts to a forward underside of the snowblower. During use of the snowblower, a user removes the bolts and wheelbase. The present invention further relates to a removable wheelbase that includes: a horizontal axle; a first wheel and a second wheel on the horizontal axle; a vertical post extending from the horizontal axle; a mounting platform at the top of the vertical post; and an attachment means inserted through the mounting platform. The mounting platform may further include a first mounting pad and a second mounting pad.

### BACKGROUND OF THE INVENTION

### Field of Invention

The present invention relates to a wheel attachment that is attached to a snowblower.

### Description of Related Art

Snowblowers are a common tool used for snow removal. The snowblower provides an easy method to remove snow from driveways, sidewalks or parking lots as needed. Snowblowers are usually self-propelled and have push handles that allow the user to push the snowblower over the snow for removal. The snowblower usually has a single set of wheels that enable the blower to maneuver over a surface during use. Snowblowers are normally stored in a warehouse, garage or otherwise when not in use. However, due to the undersurface of the snowblower and the positioning of the traditional wheels it becomes difficult to maneuver a snowblower over a flat surface for storage purposes. Further stores that sell snowblowers have difficulty maneuvering the snowblower around a show room surface based upon the construction of the snowblower. It would therefore be advantageous to have a wheelbase that can be easily mounted onto a snowblower that provides a wheelbase at a forward position of the snowblower under the blades. This feature allows the front edge of the snowblower to be above the surface and enables easy movement thereof.

### SUMMARY OF THE INVENTION

The present invention relates to a method to elevate a snowblower that includes the steps of: assembling a wheelbase, wherein said wheelbase includes a first wheel and a second wheel placed on a horizontal axle and a vertical post extending therefrom; inserting bolts through a mounting platform attached to the vertical post; and securing the bolts to a forward underside of the snowblower. During use of the snowblower, a user removes the bolts and wheelbase. The present invention further relates to a removable wheelbase that includes: a horizontal axle; a first wheel and a second wheel on the horizontal axle; a vertical post extending from the horizontal axle; a mounting platform at the top of the vertical post; and an attachment means inserted through the mounting platform. The mounting platform may further include a first mounting pad and a second mounting pad.

### BRIEF DESCRIPTION OF DRAWINGS

FIG. 1 depicts a wheel attachment for a snowblower according to the present invention.

FIG. 2 depicts a side view of the wheel attachment for a snowblower.

### DETAILED DESCRIPTION

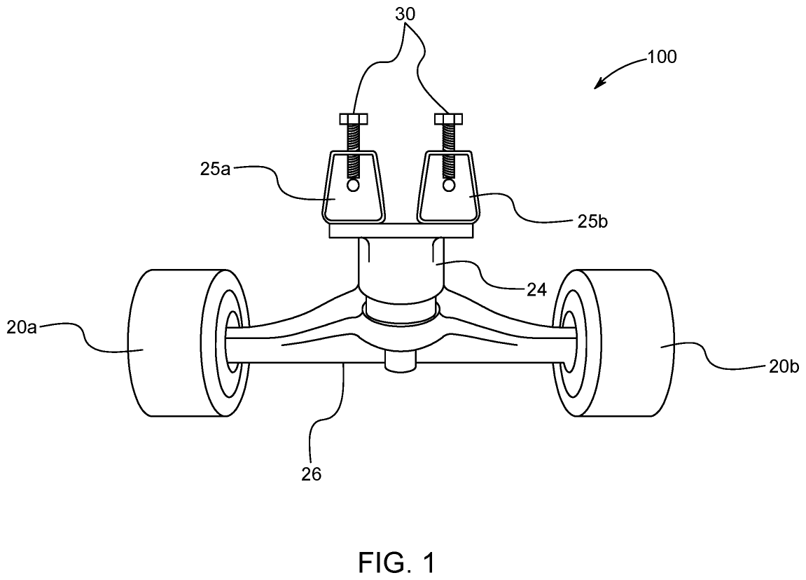

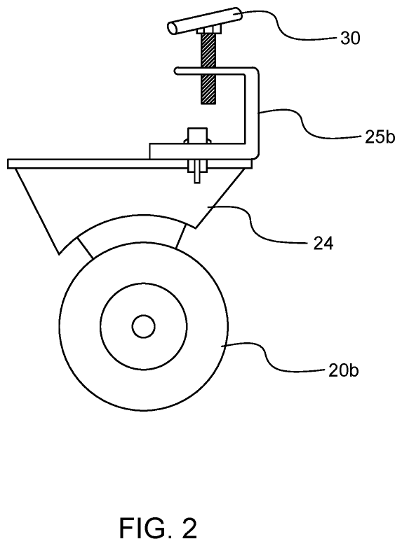

The present invention relates to a method to elevate and mount a wheelbase onto the front end of a snowblower. The present invention allows for easy movement of the snowblower over a flat surface when not in use. The mounting bracket according to the present invention is depicted in FIGS. 1 and 2. Wheelbase 100 as shown includes a first Wheel 20a and a second Wheel 20b. This wheelbase 100 includes a horizontal axle 26 and a vertical post 24 extending from the mid-line of axle 26. The post 24 includes a mounting platform with a first mounting pad 25a and a second mounting pad 25b. FIG. 2 provides a side profile of the vertical post 24. These mounting pads 25a, 25b abut the undersurface of a snowblower and therefore are easily mounted on this undersurface due to use of bolts 30 as shown in FIG. 1. Once this wheelbase 100 is placed on a snowblower the front edge of the snowblower is elevated and maneuverable due to the wheelbase 100. As such a user may easily maneuver the snowblower over a flat surface when not in use. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use

What is claimed is:

1. A method to elevate a snowblower comprising the steps of:
a. assembling a wheelbase, wherein said wheelbase includes a first wheel and a second wheel placed on a horizontal axle and a vertical post extending therefrom;
b. inserting bolts through a mounting platform attached to the vertical post; and
c. securing the bolts to a forward underside of the snowblower.

2. The method according to claim 1, removing the bolts and wheelbase during use of the snowblower.

3. A removable wheelbase comprising:
a. a horizontal axle;
b. a first wheel and a second wheel on the horizontal axle;
c. a vertical post extending from the horizontal axle;
d. a mounting platform at the top of the vertical post; and
e. an attachment means inserted through the mounting platform.

4. The removable wheelbase according to claim 3, where the mounting platform includes a first mounting pad and a second mounting pad.

5. The removable wheelbase according to claim 4, where the first mounting pad includes a hole and the second mounting pad includes a hole.

6. The removable wheelbase according to claim 5, where the attachment means includes bolts insertable through the holes.
